(19) United States
(12) Patent Application Publication
(10) Pub. No.: US 2003/0193821 A1
(43) Pub. Date: Oct. 16, 2003

(54) Inverter for producing a true sine wave

(76) Inventors: Michael Krieger, Miami Beach, FL (US); Bruce Randolph, Ft. Lauderdale, FL (US)

Correspondence Address: VENABLE, BAETJER, HOWARD AND CIVILETTI, LLP, P.O. BOX 34385, WASHINGTON, DC, 20043-9998, US

(21) Appl. No.: 10/214,340

(22) Filed: Aug. 8, 2002

Related U.S. Application Data
(60) Provisional application No. 60/371,144, filed on Apr. 10, 2002.

(51) Int. Cl. H02M 3/335

(52) U.S. Cl. 363/25

(57) ABSTRACT

A power inverter includes a transformer having a primary winding with a first and second ends and a tap between the first and second ends for receiving a DC voltage input, and a secondary winding for outputting an output waveform. A comparator compares the output waveform to a reference signal and outputs a correction signal based on the comparison. A controller receives the correction signal and provide a switching signal. The duty cycle of the switching signal is adjusted based on the correction signal. First and second switches are coupled to the first and second ends, respectively, of the primary winding. The first and second switches switch the transformer in accordance with the switching signal so that the output waveform tracks the reference signal.

### CROSS-REFERENCE TO RELATED APPLICATIONS

This application claims the benefit of U.S. Provisional Patent Application No. 60/371,144, filed Apr. 4, 2002, the disclosure of which is incorporated herein by reference.

### BACKGROUND OF THE INVENTION

The invention relates to electrical power inverters, and in particular to power inverters for converting a direct current signal into an alternating current signal.

Power inverters are known which convert direct current into alternating current. For example, Vector Products, Inc. manufactures and distributes a self-contained power inverter under the trade name MAXX POWER INVERTER and the VECTOR POWER ON BOARD series. These power inverters are connected to a 12-volt battery, for example through a cigarette lighter socket of a vehicle, for converting 12-volt direct current energy into 110-volt alternating current. Other known power inverters are disclosed, for example, in U.S. Pat. No. 5,901,056 to Hung, which is incorporated herein by reference. Such power inverters can be used to provide power to devices needing an AC power supply when only a DC power supply is available, for example, when travelling in a car or on a camping trip.

There are essentially two types of power inverters that convert a DC input into an AC output. A first type of power inverter produces what is referred to as a modified sine wave. This modified sine wave is really more of a modified square wave than a modified sine wave. The other type of power inverter is a true sine wave inverter that converts a standard 12-volt DC signal into a true sinusoidal 110-volt alternating signal at a frequency of 60 Hertz. The most prevalent way to perform the power conversion in a true sine wave inverter is to take the input 12-volt DC signal and convert it by high frequency switching of a transformer into a stepped-up AC signal. The stepped-up AC signal is then converted back again to a DC signal. Field-effect transistors (FETs), or other transistors are then used to create the sine wave output from the DC signal. The transistors for creating the sine wave are operated in a linear mode.

FETs or other transistors operated in a linear mode dissipate large amounts of power and are highly inefficient, generally less than 50% efficient. The large amounts of power dissipated by the transistors generates significant heat in the power inverter that must be dissipated. Therefore, additional precautions, for example, the use of heat sinks and fans, must be taken to dissipate the heat, adding to the size, expense and complexity of the power inverter.

Despite the above noted disadvantage of true sine wave inverters, true sine wave inverters are often preferable because they can run virtually any device that is operated by being plugged into a standard household outlet. By contrast, certain devices are not intended to be powered by a modified sine wave inverter, and therefore do not operate as intended using a power inverter that produces a modified sine wave. This is particularly true for devices that include reactive loads. For example, a transformer does not operate at its peak efficiency when it is powered by a modified sine wave, neither do motors in hand tools. These devices run less efficiently on a modified sine wave, generating more heat and having a reduced output. For example, a drill produces a lower torque running on a modified sine wave and tends to generate more heat. Additionally, televisions do not operate as well when powered by a modified sine wave as they do when powered by a true sine wave. The modified sine wave produces interference that appears as a horizontal line in the television picture.

Accordingly, there is a need for a true sine wave inverter having a simple, low-cost design and that does not have the disadvantages of the known true sine wave inverters as discussed above.

### SUMMARY OF THE INVENTION

According to an exemplary embodiment, the power inverter comprises a transformer including a primary winding having first and second ends and a center tap between the first and second ends for receiving a DC voltage input, and a secondary winding for producing an output waveform. A comparator compares the output waveform to a reference signal and outputs a correction signal based on the comparison. A controller receives the correction signal and provides a switching signal. The switching signal is provided to first and second switches coupled to the first and second ends, respectively, of the primary winding. The duty cycle of the switching signal is adjusted based on the correction signal. The first and second switches switch the transformer on and off in accordance with the switching signal so that the output waveform tracks the reference signal.

In another exemplary embodiment, the power inverter comprises a transformer that includes a primary winding with a center tap for receiving a DC input and a secondary winding outputting an output waveform; means for switching the transformer on and off at a high frequency; means for comparing the output waveform to a reference signal and for outputting a correction signal based on the comparison; and means for pulse width modulating the means for switching in order to adjust a duty cycle of the means for switching based on the correction signal.

According to another embodiment of the invention, there is provided a power inverter, comprising: a step-up transformer having a primary winding, a secondary winding, and a center tap on the primary winding adapted to be coupled to a DC voltage supply; an FET switch connected at each end of the primary winding; a sine wave generator producing a low frequency reference signal; a controller producing a high frequency signal for switching the FET switches at the rate of the high frequency signal to produce a high voltage, high frequency signal on the secondary winding; a filter coupled on the secondary winding for producing a DC output signal from the high voltage, high frequency signal; and a comparator having a first input for receiving the low frequency reference signal from the sine wave generator and a second input for receiving a signal corresponding to the stepped up DC voltage and for producing a correcting signal corresponding to a difference between the first and second inputs, wherein the controller adjusts pulse widths of the high frequency signal based on the correcting signal so that the amplitude of the DC output signal is modulated to vary between a maximum voltage and a minimum voltage at the same frequency as the low frequency reference signal in order to produce a simulated AC signal comprising a true sine wave.

According to another aspect of the invention there is provided a method for producing a true sine wave output, comprising: providing a DC input to a center tap of a primary winding of a transformer; generating a high frequency, pulse width modulated (PWM) signal; applying the high frequency PWM signal to switches at each end of the primary winding of the transformer for switching the transformer on and off at a high frequency to produce a high frequency signal output at a secondary winding of the transformer; comparing the signal output with a reference signal representing a desired output; and adjusting the pulse width modulation of the high frequency PWM signal depending on the comparison, whereby the signal output is caused to track the reference signal.

### BRIEF DESCRIPTION OF THE DRAWINGS

FIG. 1 is a circuit schematic in partial block circuit form showing the true sine wave inverter according to the invention; and

FIG. 2 is a signal diagram used to explain the operation of the circuit shown in FIG. 1.

### DETAILED DESCRIPTION OF THE INVENTION

A method and apparatus for converting a DC input signal into a true sine wave AC output signal is provided. In exemplary embodiments, a current is switched through a primary winding of a transformer using FETs or other switching means. The FETs are driven by a high frequency signal. The high frequency signal driving the FETs on the primary side of the transformer is pulse width modulated in accordance with the desired frequency of the output signal. The pulse width modulation is varied based upon a comparison of an output of the transformer with a reference signal having the desired frequency. The structure of this embodiment eliminates the heat-generating FETs or other transistors on the output side of the transformer in the known designs as discussed above. Accordingly, a simplified, cost-effective power inverter is provided.

According to an embodiment of the invention, control of the pulse width modulation (PWM) of the signal driving the FETs is achieved with a feed back loop. An output signal of the power inverter is compared to a reference signal having the desired output frequency. The reference signal, typically a 60 Hertz reference signal, is provided to one input of a means for comparing, such as a comparator, differential amplifier or other comparable device. Another input of the means for comparing is provided with the feedback output signal of the power inverter. The means for comparing produces an error signal corresponding to the difference of the two input signals. The output of the means for comparing is provided to a means for pulse width modulation (PWM), for example, a commercially available PWM integrated circuit. The PWM integrated circuit produces an output wave having a duty cycle that is a function of the error signal from the means for comparing. The output of the PWM integrated circuit is provided to a means for switching, for example, an electronic switch, FET or other type of transistor connected for switching a transformer having a DC input at a center tap of the transformer primary winding. A stepped-up voltage, high frequency signal is produced across the secondary winding of the transformer. A filter such as a low pass filter is coupled to the secondary winding for passing a DC signal having an amplitude that varies at a rate that tracks the frequency of the reference signal.

The differential amplifier or other means for comparing may be built into the PWM controller circuit that produces the high frequency signal for driving the switching FETs. A closed loop feedback circuit is formed in which the output of the transformer is modulated to look like the reference signal which, in this case, is a 60 Hertz sine wave. That is, the output of the transformer is caused to vary between the 0-volts and the maximum stepped up voltage at the frequency rate of the 60 Hertz reference sine wave, thereby producing a true sine wave output.

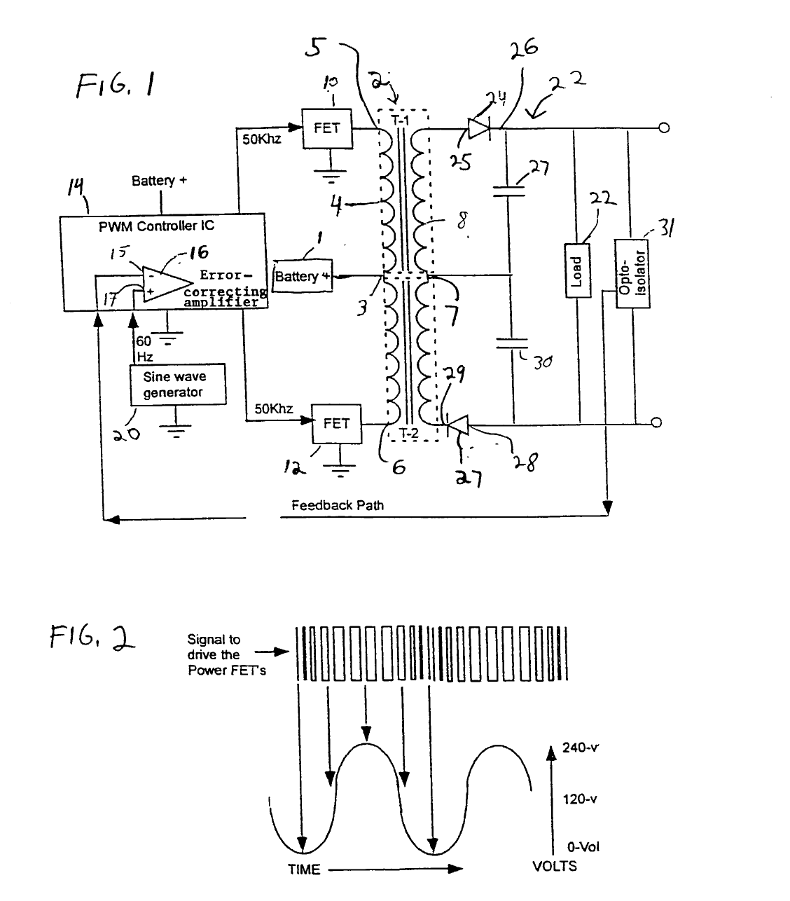

Referring now to FIG. 1, there is shown a true sine wave power inverter according to an embodiment of the invention. The power inverter can convert power from a DC source, such as a battery 1, into AC power. A transformer 2 is provided to step-up or step-down the voltage of the battery 1, as needed. In the exemplary embodiment discussed herein, transformer 2 is a step-up transformer. Transformer 2 includes a primary winding 4 and a secondary winding 8. Here, circuitry connected to the primary winding 4 is referred to as the input side of the power inverter and circuitry connected to the secondary winding 8 is referred to as the output side. Initially, the input side will be described. The battery 1 is coupled to a center tap 3 of the primary winding 4 of the transformer 2. Switches 10, 12 are coupled, respectively to opposite ends 5, 6 of the primary winding 4 of the transformer 2. The switches 10, 12 may be FETs or other suitable electronic switches. The switches 10, 12 switch current flow through the primary winding 4 of the transformer 2 to induce a high voltage, high frequency signal in the secondary winding 8. The switching of the switches 10, 12 is controlled by a pulse width modulation (PWM) controller 14. The PWM controller 14 may be a pulse width modulation controller IC, such as a Motorola TL 494. The controller 14 outputs a switching signal typically in the form of a variable duty cycle square wave that controls when the switches turn on and off.

A signal comparator 16 is associated with the controller 14. The signal comparator 16 may be a portion of the integrated circuit forming the controller 14, as is the case with the Motorola TL 494. The signal comparator 16 is preferably a differential amplifier having a negative input 15 coupled to a feedback of the output signal of the power inverter and a positive input 17 receiving a reference signal. The reference signal represents a waveform that corresponds to a waveform desired at the output of the power inverter. In the present example, the reference signal is a 60-Hertz sine wave, as this is the American standard for power. The reference signal may be provided from a signal generator 20, which may comprise, for example, a known operational amplifier adapted to produce the sine wave. Both the PWM controller IC 14 and the signal generator 20 preferably draw their power from the battery 1.

Turning now to the output side of the power inverter, a load 22 is arranged across the secondary winding 8 of the transformer 2. A filter 22 is arranged to filter the output of the secondary winding 8. The filter 22 removes unwanted harmonics and frequencies from the output waveform. Any suitable filter can be used. In the embodiment illustrated, the filter 22 comprises a diode 24 having an anode 25 connected to one end of the secondary winding 8. A capacitor 27 is coupled between the cathode 26 of diode 24 and a center tap 7 on the secondary winding 8. Another diode 27 has its cathode 29 coupled to the other end of secondary winding 8. A capacitor 30 is coupled between the center tap 7 of the secondary winding 8 and an anode 28 of diode 27. The filter 22 is arranged to produce a filtered DC output across load 22. An opto-isolator 31 is connected in parallel with load 22. The opto-isolator 31 is used to protect the PWM controller IC 14 from power surges and to develop a low voltage signal proportional to the voltage across load 29, which is fed back to the negative input 15 of differential amplifier 16, for comparison with the reference signal.

The operation of a power inverter according to the above-described embodiment of the invention will now be described with reference to FIGS. 1 and 2. A DC input is provided to the transformer 2, preferably at the center tap 3 of the primary winding 4 of the transformer 2. The transformer 2 is switched on and off at a high frequency to produce an AC output at the secondary winding 8 of the transformer 2. The switching of the transformer is accomplished with switches coupled at either end of the primary winding 4. Here, high frequency means frequencies of 20 kHz or higher, and preferably frequencies 50 kHz or higher. These frequencies are “relatively high” compared to the 60-Hertz frequency corresponding to the desired output frequency. A duty cycle of each switch, that is the length of time each switch is closed, is controlled via a pulse width modulated square-wave signal.

The output of the power inverter is compared to the reference signal, which in the exemplary embodiment is a 60 Hz reference signal that is generated by the signal generator 20. The comparison of the reference signal and the output of the power inverter are performed by comparator 16 in the form of a differential amplifier. The output of the differential amplifier 20 is a 60 Hz error signal, or more properly a correcting signal which is employed to adjust the pulse width of the square wave output from the PWM controller 14. Stated another way, the correcting signal output of the differentiated amplifier is used to constantly adjust the duty cycle of the high frequency square wave signal driving the switching FETs to vary between a maximum pulse width and a minimum pulse width at the 60 Hertz rate.

Switching the FETs on and off in this manner induces a high frequency signal in the secondary winding 8 of the transformer 4 whose amplitude varies between a maximum stepped up voltage and zero volts. As a result, the filtered DC output across load 22 comprises a DC signal that is modulated at a rate of 60 Hertz to vary between a maximum voltage, for example 220-volts and 0-volts. This modulated DC signal simulates an AC signal and comprises a true sine wave. That is, the PWM controller IC constantly adjusts the pulse width modulation of the high frequency signal driving the FETs so that the filtered DC output of the transformer appears exactly the same as the sine wave reference signal. In effect, the filtered DC output is adjusted at the rate of the high frequency signal, in this example 50,000 times per second, to look like the 60-Hertz reference signal.

As shown in FIG. 2, the signal that drives the FETs is a pulse width modulated signal that increases and decreases in pulse width in a sinusoidal fashion. A wider pulse width produces a higher DC voltage on the output side of the transformer and a smaller pulse width produces a lower DC voltage on the output. This can be seen by the sinusoidal wave below the pulse width modulated signal of FIG. 2.

In operation, the FETs are switched at a high rate, for example 50 kHz, to develop the stepped-up voltage, high frequency signal across the secondary winding 8, and resulting in a DC voltage across the capacitors 27 and 30. Further, because the 50 kHz switching signal is also pulse width modulated with a 60 Hz frequency, the filtered DC output of the transformer is also modulated at 60 Hertz. That is, the DC voltage across the capacitors is modulated in the manner of a true sine wave to simulate an AC signal. In the exemplary embodiment, the output is about 220 VDC varying from 0-220 VDC at a 60 Hz sinusoidal rate. This equates to a conventional output from a standard household socket. The benefits are great in that there is reduced heat because the usual heat-generating FETs at the output are eliminated.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

What is claimed is:

1. A power inverter, comprising:
a transformer including a primary winding having first and second ends and a tap between the first and second ends for receiving a DC voltage input, and a secondary winding for outputting an output waveform;
a comparator comparing the output waveform to a reference signal and outputting a correction signal based on the comparison;
a controller receiving the correction signal and providing a switching signal, a duty cycle of the switching signal being adjusted based on the correction signal; and
a first switch coupled to the first end of the primary winding and a second switch coupled to the second end of the primary winding, the first and second switch switching the transformer in accordance with the switching signal so that the output waveform tracks the reference signal.

2. The power inverter of claim 1, wherein the reference signal is a sine wave.

3. The power of inverter of claim 2, wherein the sine wave has a frequency of 60 Hz.

4. The power inverter of claim 1, further comprising a signal generator coupled to the comparator and generating the reference signal.

5. The power inverter of claim 1, wherein the comparator comprises a differential amplifier.

6. The power inverter of claim 1, wherein the switches comprises transistors.

7. The power inverter of claim 2, wherein the switches are switched at a relatively high frequency.

8. The power inverter of claim 7, wherein the relatively high frequency is 50 kHz or greater.

9. The power inverter of claim 1, further comprising a low pass filter coupled to the secondary winding for passing a DC voltage signal that has its amplitude modulated in accordance with a shape of the reference signal, the amplitude modulated DC voltage constituting the output waveform.

10. The power inverter of claim 1, wherein the DC voltage input provides operating power to the controller and the comparator.

11. A power inverter, comprising:
a transformer including a primary winding receiving a DC input at a center tap and a secondary winding outputting an output waveform.
means for generating a reference signal having a desired shape for the output waveform;
means for switching the transformer at a high frequency;
means for comparing the output waveform to the reference signal and for outputting a correction signal based on the comparison; and
means for pulse width modulating the means for switching and for adjusting a duty cycle of the means for switching based on the correction signal, so that the output waveform tracks the reference signal.

12. The power inverter of claim 11, wherein the reference signal is sinusoidal.

13. The power inverter of claim 11, wherein the means for comparing comprises a differential amplifier.

14. The power inverter of claim 11, wherein the means for switching comprise field-effect transistors.

15. The power inverter of claim 11, wherein the switches are switched at a relatively high frequency compared to the frequency of the reference signal.

16. The power inverter of claim 15, wherein the relatively high frequency is greater than or equal to 50 kHz.

17. The power inverter of claim 11, further comprising a low pass filter coupled to the secondary winding for passing a DC voltage signal that has its amplitude modulated in accordance with the shape of the reference signal, the amplitude modulated DC voltage constituting the output waveform.

18. The power inverter of claim 11, wherein the DC input signal provides operating power to the means for comparing and the means for pulse width modulation.

19. A power inverter, comprising:
a step-up transformer having a primary winding, a secondary winding, and a center tap on the primary winding adapted to be coupled to a DC voltage supply;
an FET switch connected at each end of the primary winding;
a sine wave generator producing a low frequency reference signal;
a controller producing a high frequency signal for switching the FET switches at the rate of the high frequency signal to produce a high voltage, high frequency signal on the secondary winding;
a filter coupled on the secondary winding for producing a DC output signal from the high voltage, high frequency signal; and
a comparator having a first input for receiving the low frequency reference signal from the sine wave generator and a second input for receiving a signal corresponding to the stepped up DC voltage and for producing a correcting signal corresponding to a difference between the first and second inputs, wherein
the controller adjusts pulse widths of the high frequency signal based on the correcting signal so that the amplitude of the DC output signal is modulated to vary between a maximum voltage and a minimum voltage at the same frequency as the low frequency reference signal in order to produce a simulated AC signal comprising a true sine wave.

20. In a power inverter, a method for producing a true sine wave output, comprising:
providing a DC input to a center tap of a primary winding of a transformer;
generating a high frequency pulse width modulated (PWM) signal;
applying the high frequency PWM signal to switches at each end of the primary winding of the transformer for switching the transformer on and off at a high frequency to produce a high frequency signal output at a secondary winding of the transformer;
comparing the signal output with a reference signal representing a desired output; and
adjusting the pulse width modulation of high frequency PWM signal depending on the comparison, whereby the signal output is caused to track the reference signal.
